(19) United States
(12) Patent Application Publication
(10) Pub. No.: US 2010/0077603 A1
(43) Pub. Date: Apr. 1, 2010

(54) SEALED CELL AND METHOD FOR MANUFACTURING THE SAME

(75) Inventors: Syuichi Yamashita, Itano-gun (JP); Hiromitsu Suwa, Naruto-shi (JP); Kazuo Tomimoto, Itano-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/568,770

(22) Filed: Sep. 29, 2009

(30) Foreign Application Priority Data
Sep. 30, 2008 (JP) 2008-254430

(51) Int. Cl. H01M 10/04

(52) U.S. Cl. 29/623.2

(57) ABSTRACT

A method for manufacturing a sealed cell includes the following steps. A step of producing an iron-based terminal cap, which includes an external terminal projecting toward the outside of the cell, a flange, and a hole in the flange, the hole having a diameter smaller on the inner side than on the outer side of the cell. A step of producing an aluminum-based safety valve, which includes a conductive contact portion projecting toward the inside of the cell, a peripheral portion, and a pin-like projection in the peripheral portion. A step of riveting the projection and the hole together by inserting the projection into the hole and crushing the tip of the projection. A step of welding the terminal cap and the safety valve by applying high-energy radiation to the part of the cap that is in the vicinity of the riveted part.

### BACKGROUND OF THE INVENTION

1. Field of the Invention

The present invention relates to a sealed cell, and more specifically, to a sealed cell having a highly conductive sealing body with a safety valve.

2. Background Art

Non-aqueous electrolyte secondary cells are widely used as the driving power sources of portable devices and electric tools because of their high energy density and high capacity.

These cells using flammable organic solvents are required to ensure safety, and for this reason, the sealing body for sealing such a cell includes a current breaking mechanism which operates when the cell internal pressure increases.

FIG. 7 shows a sealed cell having a sealing body 10 including a conventional current breaking mechanism. The sealing body 10 includes a terminal cap 5, a safety valve 3 disposed on the inner surface of the terminal cap 5, a terminal plate 1 disposed on the inner surface of the safety valve 3, and an insulating member 2 providing isolation between the safety valve 3 and the terminal plate 1. The flange of the terminal cap 5 and the periphery of the safety valve 3 are in conductive contact with each other.

The current breaking mechanism of the sealed cell operates as follows. When the cell internal pressure increases, the safety valve 3 is pushed up toward the outside of the cell. This results in the breakage of the crushing groove of the terminal plate 1, which is connected to a conductive contact portion 3a of the safety valve 3, thereby interrupting the current supply to the terminal cap 5.

In such a current breaking mechanism, the safety valve is required to be made of a material susceptible to deformation so that the above-described operation can be performed smoothly. The terminal cap, on the other hand, is required to be made of a material having a certain strength because it is exposed to the external environment. To satisfy these requirements, the safety valve is made of a flexible aluminum-based material, and the terminal cap is made of a rigid iron-based material.

In non-aqueous electrolyte secondary cells that are designed to provide large current discharge performance in electric tools and similar devices, the cell temperature may be heated up to 80° C. or more during discharge. When the cells are repeatedly exposed to high temperatures during long-term use, resin components such as the insulating member 2 and a gasket 30 become less flexible. This reduces the contact between the terminal cap 5 and the safety valve 3 in the vicinity of the resin components. As a result, the conduction therebetween becomes unstable, thereby tending to increase the internal resistance of the cell. For this reason, it is desired to firmly join the terminal cap 5 and the safety valve 3.

Although welding is an excellent method for joining different materials, it is difficult to firmly weld the materials very different in melting point or electrical characteristics together, such as an iron-based material and an aluminum-based material.

Well-known techniques on the sealing body include the following Patent Documents 1 to 4.

Patent Document 1: Japanese Patent Unexamined Publication No. 2006-351512

Patent Document 2: Japanese Patent Unexamined Publication No. 2000-90892

Patent Document 3: Japanese Patent Examined Publication No. H05-74904

Patent Document 4: Japanese Patent Unexamined Publication No. 2007-194167

Patent Document 1 shows a sealing body including a metal filter and other members stored therein, such as a resin inner gasket, a metal cap, and a safety mechanism having a metallic explosion-proof valve body and a thin-walled metallic valve body. The metal filter and all metallic members stored therein are laser-welded together. In this technique, the metal cap is made of nickel-plated iron, and the other members are made of aluminum; however, as described above, the large difference in melting point between aluminum and iron makes it impossible to firmly laser-weld them. This unstable state of welding causes the internal resistance of the cell to be unstable.

Patent Document 2 shows a sealing body in which the periphery of an iron lid cap is caulked around and spot-welded to the periphery of an aluminum lid case; however, as described above, the large difference in electrical characteristics between aluminum and iron makes it impossible to firmly spot weld them. This unstable state of welding causes the internal resistance of the cell to be unstable.

Patent Document 3 shows a sealing body including the following cell cap and metal plate. The cell cap includes a cylindrical portion and a flange, which is formed on the outer periphery of the cylindrical portion and has a plurality of holes. The metal plate includes a plurality of projections whose height is larger than the thickness of the cell cap. The holes of the cell cap are engaged with the projections of the metal plate so as to pressure-weld the end faces of the projections of the metal plate projecting beyond the holes of the cell cap, thereby fixing the cell cap and the metal plate to each other. In this technique, however, the electric connection between the cell cap and the metal plate is made by pressure welding, causing the internal resistance of the cell to be unstable.

Patent Document 4 shows a sealing body having a terminal cap made of an iron-based material and a safety valve made of an aluminum-based material, which are welded together as follows. First, a gap is provided in at least one of the flange of the terminal cap and the flange of the safety valve, and then, high-energy radiation is applied from the terminal cap side to a position corresponding to the gap. It is difficult, however, to pinpoint the position of the gap as the target to be welded from the terminal cap side and to verify the successful completion of welding.

### SUMMARY OF THE INVENTION

In view of the conventional problems, it is an object of the present invention to provide a sealed cell having a highly conductive sealing body with a safety valve and a method for manufacturing the same.

The method according to the present invention for manufacturing a sealed cell sealed by caulking a sealing body around the opening of a bottomed cylindrical outer can includes the steps of:

producing a terminal cap made of an iron-based material, the terminal cap including an external terminal projecting toward the outside of the sealed cell, a flange in the periphery of the external terminal, and a hole in the flange, the hole having a diameter smaller on the inner side than on the outer side of the sealed cell;

producing a safety valve made of an aluminum-based material, the safety valve including a conductive contact portion projecting toward the inside of the sealed cell, a peripheral portion in the periphery of the conductive contact portion, and a pin-like projection in the peripheral portion;

riveting the pin-like projection of the safety valve and the hole of the terminal cap together by inserting the pin-like projection into the hole and crushing the tip of the pin-like projection; and

welding the terminal cap and the safety valve by applying high-energy radiation to the part of the terminal cap that is in the vicinity of a riveted part.

With this structure, the terminal cap and the safety valve are riveted together, and then, high-energy radiation is applied to the terminal cap made of an iron-based material having a high melting point so as to perform welding. The high-energy radiation melts the iron-based material having a high melting point in the terminal cap, and then the molten iron-based material flows into the riveted part in the vicinity of the radiation spot. Then, the thermal energy of the molten iron-based material melts the aluminum-based material (the pin-like projection of the safety valve) in the riveted part. As a result, the safety valve and the terminal cap are welded successfully and firmly, making the resistance therebetween stable and small. This results in a sealed cell having a highly conductive sealing body with a safety valve.

In contrast, if the high-energy radiation is applied to the safety valve, one of these problems (1) and (2) occurs.

(1) When energy high enough only to melt the aluminum-based material having a low melting point is applied, the iron-based material having a high melting point hardly melts, thus failing to provide excellent welding performance.

(2) When energy high enough to melt the iron-based material having a high melting point is applied, the aluminum-based material having a low melting point evaporates, thus failing to provide excellent welding performance.

The term “iron-based material” includes iron and iron alloys, and the term “aluminum-based material” includes pure aluminum and aluminum alloys.

In the above-described sealed cell, the hole of the terminal cap may be a counterbored hole.

The term “counterbored hole” means a hole having a large diameter portion, a small diameter portion, and a stepped portion therebetween as shown in FIG. 2A. The stepped portion facilitates riveting.

The high-energy radiation is preferably a laser beam, which can easily control energy.

The high-energy radiation is preferably applied to the wall surface of the hole of the terminal cap that is in the vicinity of the riveted part so that the molten iron material can flow into the riveted part efficiently.

In order to prevent the rotation of the terminal cap and the safety valve after the riveting, it is preferable that the terminal cap has two or more holes and that the safety valve has two or more pin-like projections. It is also preferable that the numbers of the holes and the pin-like projections do not exceed four from the trade-off between cost and effect.

The clearance between the diameter of the pin-like projections of the safety valve and the small diameter of the holes of the terminal cap is preferably 0.01 to 0.1 mm. The pin-like projections of the safety valve preferably project 0.3 to 0.7 mm from the stepped portions of the holes of the terminal cap toward the outside the cell. The large diameter of the holes of the terminal cap that is on the outer side of the cell is preferably larger by 0.2 to 0.7 mm than the small diameter of the holes that is on the inner side of the cell.

The welding between the terminal cap and the safety valve may be applied to the entire outer periphery of the riveted part, or may be applied to a single to several spots thereof.

A sealed cell manufactured according to the method for manufacturing a sealed cell according to the present invention includes:

a bottomed cylindrical outer can; and

a sealing body caulked around the opening of the outer can, wherein

the sealing body includes:
a terminal cap made of an iron-based material, the terminal cap including an external terminal projecting toward the outside of the sealed cell; and a flange in the periphery of the external terminal; and
a safety valve made of an aluminum-based material and disposed on the inner side of the sealed cell than the terminal cap, the safety valve including a conductive contact portion projecting toward the inside of the sealed cell, and a peripheral portion in the periphery of the conductive contact portion, wherein

the flange of the terminal cap and the peripheral portion of the safety valve are welded together to form a welded part;

the welded part is positioned between the inner and outer surfaces of the flange; and

the welded part is provided in the center thereof with a material of the safety valve, and in the periphery thereof with a melted-solidified region in which the material of the terminal cap and the material of the safety valve are blended together.

Thus, the present invention provides a sealed cell having a highly conductive sealing body with a safety valve, allowing a sealed cell including this sealing body to have a high current extraction efficiency.

### BRIEF DESCRIPTION OF THE DRAWING

FIG. 1 is an enlarged sectional view of an essential part of a sealed cell according to the present invention.

FIG. 2A shows a terminal cap of a sealing body of the sealed cell according to the present invention, and FIG. 2B shows a safety valve of the sealing body of the sealed cell according to the present invention.

FIGS. 3A to 3E show a process for fixing the terminal cap and the safety valve to each other in the sealed cell according to the present invention: FIGS. 3A to 3C show a riveting step, and FIGS. 3D and 3E show a welding step.

FIGS. 4A to 4D show a process for producing the terminal cap of the sealed cell according to the present invention.

FIGS. 5A to 5C show a process for producing the safety valve of the sealed cell according to the present invention.

FIGS. 6A and 6B show a process for welding together a terminal cap and a safety valve of a sealed cell according to Comparative Example 1.

FIG. 7 is an enlarged sectional view of an essential part of a conventional sealed cell.

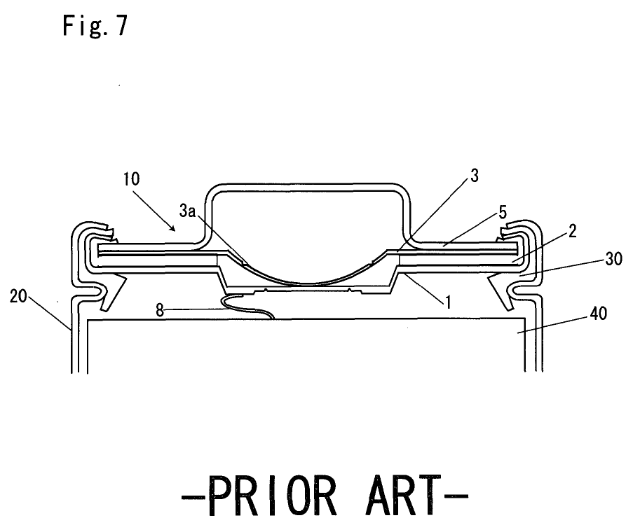

### DETAILED DESCRIPTION OF THE INVENTION EMBODIMENT

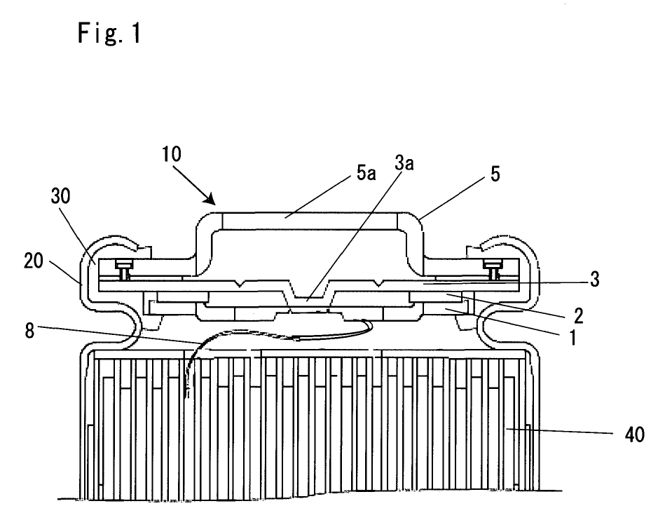

An embodiment of the present invention will be described as follows with reference to drawings. FIG. 1 is an enlarged sectional view of an essential part of a sealed cell according to the embodiment.

As shown in FIG. 1, the sealed cell according to the embodiment includes an outer can 20 storing an electrode assembly 40 and a non-aqueous electrolyte therein, and a sealing body 10 caulked around the opening of the outer can 20 via an insulating gasket 30.

The sealing body 10 includes a terminal plate 1, a terminal cap 5, a safety valve 3, and an insulating member 2. The terminal plate 1 is electrically connected to either the positive or negative electrode of the electrode assembly 40 via an electrode tab 8. The terminal cap 5 includes an external terminal 5a projecting toward the outside of the cell. The safety valve 3 is disposed between the terminal plate 1 and the terminal cap 5 and disconnects the electric connection therebetween by being deformed when the cell internal pressure increases. The insulating member 2 prevents the electric contact between the safety valve 3 and the terminal plate 1 when the safety valve 3 interrupts the flow of current. The electrode assembly 40 is electrically connected to the terminal plate 1 via the electrode tab 8.

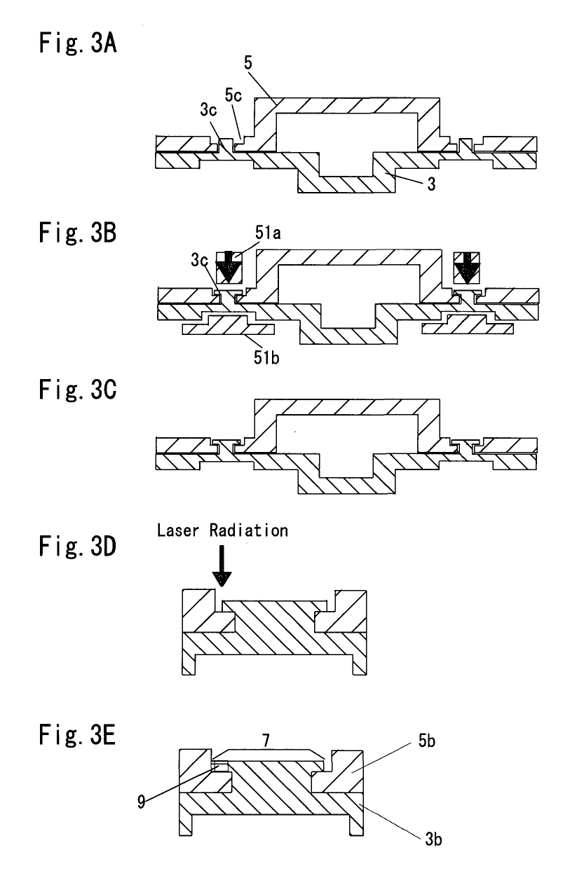

The peripheral portion of the safety valve 3 and the flange 5b of the terminal cap 5 are fixed to each other by laser welding. The welded part is shown in FIG. 3E. The welded part 7 where the terminal cap 5 and the safety valve (see FIG. 1) are welded together is disposed between the inner and outer surfaces of a flange 5b of the terminal cap 5. The welded part 7 is provided at its center with aluminum as the material of a peripheral portion 3b of the safety valve 3. The welded part 7 is also provided in its periphery with a melted-solidified region 9 in which the iron as the material of the flange 5b and the aluminum as the material of the peripheral portion 3b are blended together. In FIG. 3E, only the melted-solidified region 9 on the left side is exposed to laser radiation.

### Example 1

The present invention will be described in detail using some examples. Cells of Example 1 were manufactured using the positive electrode, the negative electrode, the electrode assembly, the sealing body, and the electrolytic solution which were produced as follows.

### Production of the Positive Electrode

Lithium cobalt oxide (LiCoO₂) as a positive electrode active material, acetylene black, graphite, or the like as a carbon-based conductive agent, and polyvinylidene fluoride (PVDF) as a binder were weighed in a mass ratio of 90:5:5, dissolved, for example, in N-methyl-2-pyrrolidone as an organic solvent, and mixed together to prepare a positive electrode active material slurry.

The slurry was uniformly applied to both sides of a positive electrode core body made of 20 μm thick aluminum foil using a die coater, a doctor blade, or the like.

The electrode plate thus obtained was put in a dryer to remove the organic solvent so as to produce a dried electrode plate. The dried electrode plate was rolled by a roll press machine, cut in size so as to produce a positive electrode plate.

### Production of the Negative Electrode

Artificial graphite as a negative electrode active material, styrene-butadiene rubber as a binder, and carboxymethylcellulose as a viscosity improver were weighed in a mass ratio of 98:1:1, mixed with an appropriate amount of water so as to prepare a negative electrode active material slurry.

The slurry was uniformly applied to both sides of a negative electrode core body made of 15 μm thick copper foil using a die coater, a doctor blade, or the like.

The electrode plate thus obtained was put in a dryer to remove water so as to produce a dried electrode plate. The dried electrode plate was rolled by a roll press machine, cut in size so as to produce a negative electrode plate.

### Production of the Electrode Assembly

The positive and negative electrodes thus produced were wound together with a separator made of a polyethylene microporous film by a winder, and applied with an insulating winding-end tape so as to complete a wound electrode assembly.

### Production of the Sealing Body

The sealing body 10 was produced in the following order: a terminal cap production step, a safety value production step, a riveting step, and a welding step.

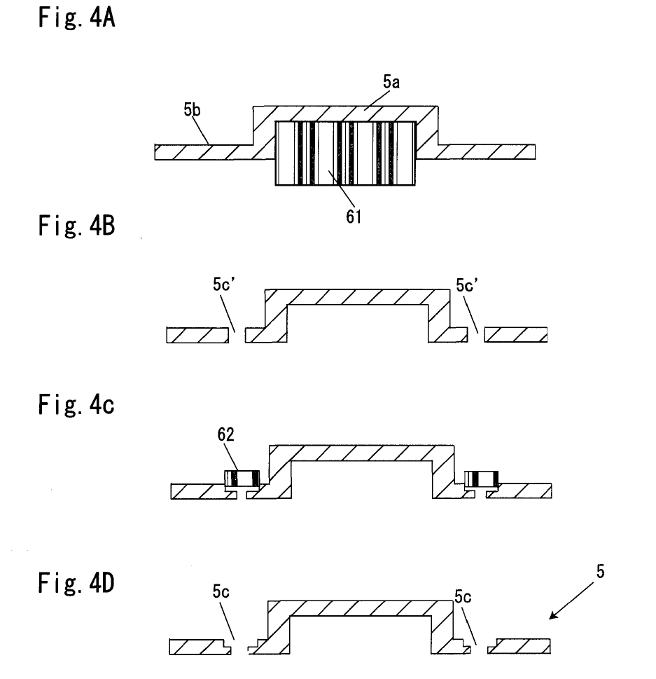

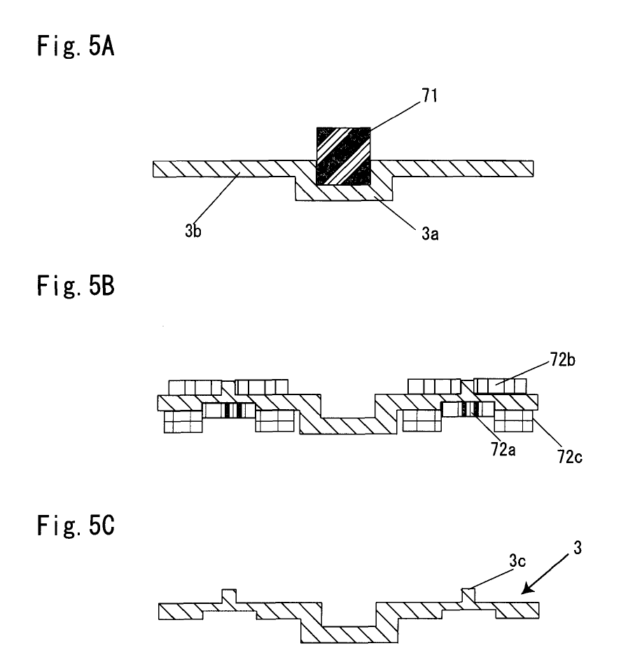

FIGS. 4A to 4D show a process for producing the terminal cap 5, and FIGS. 5A to 5C show a process for producing the safety valve 3. FIGS. 3A to 3E show a process for fixing the terminal cap 5 and the safety valve 3 to each other: FIGS. 3A to 3C show a riveting step, and FIGS. 3D and 3E show a welding step.

### Terminal Cap Production Step

A nickel-plated iron plate was pressed in its center by a press die 61 so as to form an external terminal (a projection) 5a and a flange (the outer periphery of the projection) 5b as shown in FIG. 4A.

Then, the flange 5b was provided with perforated holes 5c′ as shown in FIG. 4B.

The holes 5c′ were pressed from above by a press die 62 so as to partially increase their diameter as shown in FIG. 4C. At this moment, the diameter of the opposite side (the bottom side) of the holes 5c′ becomes smaller than the state shown in FIG. 4B because the material travels when pressed.

Then, the holes were punched again to increase the diameter of their bottom side as shown in FIG. 4D, which had been reduced by the pressing.

Finally, the iron plate was punched out into a disk so as to complete the terminal cap 5 having counterbored holes 5c.

### Safety Valve Production Step

An aluminum plate was pressed in its center by a press die 71 so as to form a conductive contact portion (a recess) 3a and the peripheral portion (the outer periphery of the recess) 3b as shown in FIG. 5A.

Then, the peripheral portion 3b was pushed from the bottom by press dies 72a, 72b, and 72c so as to form pin-like projections 3c as shown in FIG. 5B. Finally, the aluminum plate was punched out into a disk so as to complete the safety valve 3 as shown in FIG. 5C.

In this production method, hollowed portions are formed on the side opposite to the pin-like projections 3c on the aluminum plate as a result of deformation due to pressing as shown in FIG. 5C; however, these portions are not essential components of the present invention.

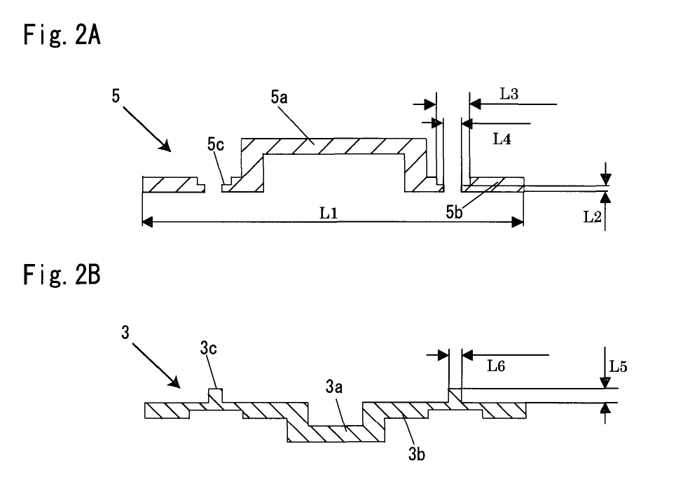

As shown in FIGS. 2A and 2B, components of the sealed cell in the embodiment have the following dimensions. The terminal cap 5 has a diameter L1 of 16.5 mm and a thickness of 0.3 mm. The counterbored holes 5c have a diameter L3 of 1.4 mm in the large-diameter portion, a diameter L4 of 1.0 mm in the small-diameter portion, and a height L2 of 0.2 mm in the small-diameter portion. The safety valve 3 has a diameter of 16.4 mm and a thickness of 0.4 mm. The pin-like projections 3c have a height L5 of 0.5 mm. The pin-like projections 3c have a diameter L6 of 0.9 mm.

The safety valve 3 has two pin-like projections, and the terminal cap 5 has two holes.

### Riveting Step

The terminal cap 5 was placed on the upper surface of the safety valve 3 in such a manner that the pin-like projections 3c of the safety valve 3 were inserted into the counterbored holes 5c of the terminal cap 5 as shown in FIG. 3A.

Next, the tips of the pin-like projections 3c were pressed from above and below and crushed by rivet fasteners 51a and 51b so as to form riveted parts, thus riveting the safety valve 3 and the terminal cap 5 together as shown in FIGS. 3B and 3C.

### Welding Step

A laser beam was applied to the wall surfaces of the holes of the terminal cap that are in the vicinity of the riveted parts as shown in FIG. 3D so as to weld the riveted parts as shown in FIG. 3E.

Finally, the aluminum terminal plate 1 was welded to the bottom surface of the safety valve 3 via the polypropylene insulating member 2 so as to complete the sealing body 10.

### Preparation of the Electrolytic Solution

An electrolytic solution was produced by forming a non-aqueous solvent containing ethylene carbonate (EC), propylene carbonate (PC), and diethyl carbonate (DEC) in a volume ratio of 1:1:8 (in terms of 1 atm at 25° C.), and then dissolving LiPF₆ as an electrolyte salt at 1.0 M (mol/L) in this non-aqueous solvent.

### Assembly of the Cell

The negative electrode current collector of the electrode assembly was welded to the bottom of a cylindrical outer can, and the outer can was filled with the electrolytic solution. The terminal plate 1 of the sealing body 10 and the positive electrode current collector were electrically connected via the electrode tab 8. Finally, the opening of the outer can was caulked and sealed via the polypropylene gasket 30 so as to complete the cell according to Example 1.

### Comparative Example 1

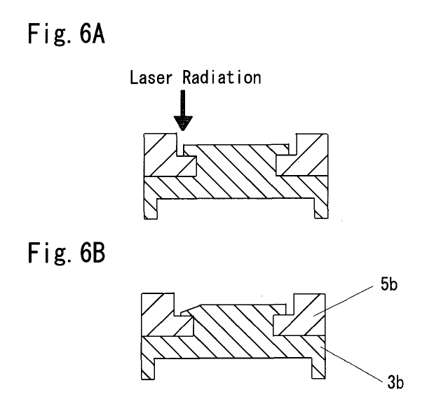

Cells according to Comparative Example 1 were manufactured in the same manner as in Example 1 except that the laser radiation (with the same energy as in Example 1) was applied to the aluminum (the pin-like projections 3c) of the riveted parts as shown in FIGS. 6A and 6B.

### Comparative Example 2

Cells according to Comparative Example 2 were manufactured in the same manner as in Example 1 except that the riveted parts were not exposed to laser radiation (the process went as far as the riveting step).

### Measurement of the Resistance

Thirty cells were manufactured as each of Example 1 and Comparative Examples 1 and 2. A total of 90 cells were charged at a constant current of 1 It (1250 mA) until the voltage reached 4.2V, and then charged at a constant voltage of 4.2V until the current reached 0.05 It (62.5 mA). Then, the cells were kept for ten days in a constant temperature chamber of 75° C. and a humidity of 90%. The sealing bodies of these cells were measured for their electric resistance after riveting, after laser welding, and after storage. The results are show in Table 1 below.

TABLE 1

| | resistance (mΩ) | | |
|---|---|---|---|
| | after | after laser | after |
| | riveting | welding | storage |
| Example 1 | 0.4(0.2-1.1) | 0.1(0.1-0.1) | 0.1(0.1-0.1) |
| Comparative | 0.5(0.2-1.4) | 0.3(0.1-0.9) | 0.6(0.4-1.3) |
| Example 1 | | | |
| Comparative | 0.4(0.2-1.1) | — | 0.6(0.3-1.8) |
| Example 2 | | | |

In Table 1, the values outside and inside the parentheses indicate mean values and actual measurement values, respectively.

The results in Table 1 indicate the following. With respect to mean values, Example 1 in which laser welding is applied to the terminal cap after riveting, the resistance is 0.1 mΩ both after laser welding and after storage. Comparative Example 1 in which laser radiation is applied to the safety valve, the resistance is 0.3 mΩ after laser welding and 0.6 mΩ after storage, and Comparative Example 2 in which laser welding is not applied, the resistance is 0.6 mΩ after storage, which are larger than in Example 1.

With respect to actual measurement values, on the other hand, Example 1 shows a resistance of 0.1 mΩ both after laser welding and after storage. In contrast, in Comparative Example 1, the resistance is 0.1 to 0.9 mΩ after laser welding, and is 0.4 to 1.3 mΩ after storage, and in Comparative Example 2, the resistance is 0.3 to 1.8 mΩ after storage, showing larger variations than in Example 1.

These results are considered to be due to the following reasons. In Comparative Example 2 in which laser welding is not applied, the electric contact between the safety valve and the terminal cap is made only by riveting them at the riveted parts. As a result, it is impossible to provide a resistance that is stable (no variations) and sufficiently small. In Comparative Example 1 in which welding is made by applying laser radiation to aluminum having a low melting point. This causes the aluminum to be evaporated by laser heat, thus failing to provide excellent and firm welding performance, and also failing to provide a resistance that is stable and sufficiently small. In Example 1, on the other hand, welding is made by applying laser radiation to iron having a high melting point. The molten iron flows into the riveted parts, and the residual heat of the molten iron partially melts the aluminum having a low melting point so as to join the terminal cap and the safety valve. As a result, the welded part 7 is provided with melted-solidified region 9 in which the iron and the aluminum are blended together as shown in FIG. 3E so as to provide excellent welding performance. This improves the electric contact between the safety valve and the terminal cap, and hence, reduces the resistance. Especially when a cell is stored in a high-temperature high-humidity environment, the contact between the safety valve and the terminal cap tends to be reduced. In Example 1 in which the welding be tweenthe safety valve and the terminal cap is excellent and firm, however, storage in a high-temperature high-humidity environment never causes an increase in the resistance.

### Additions

The terminal cap production step and the safety valve production step are not limited to the method described in the embodiment: for example, a cutting method can be used instead.

Examples of the positive electrode active material include lithium-containing transition metal composite oxides, which can be used alone or in combination of two or more thereof. Examples of the lithium-containing transition metal composite oxides include lithium cobalt oxide used in the above-described examples, lithium nickel oxide (LiNiO₂), lithium manganese oxide (LiMn₂O₄), lithium iron phosphate (LiFePO₄), lithium-manganese-nickel-cobalt oxide (LiMnₓNi_{y}Co_{z}O₂ wherein x+y+z=1), and other oxides obtained by replacing part of a transition metal by another element.

Examples of the negative electrode material include carbonaceous materials and mixtures of a carbonaceous material and at least one selected from the group consisting of lithium, a lithium alloy, and a metal oxide capable of absorbing and desorbing lithium. Examples of the carbonaceous materials include natural graphite, carbon black, cokes, glassy carbons, carbon fibers, and sintered bodies thereof.

Besides the aforementioned combination of EC, PC, and DEC, the non-aqueous solvent can be a mixture of one or more high dielectric solvent having a high solubility of lithium salt and one or more low-viscosity solvent. Examples of the high dielectric solvent include ethylene carbonate, propylene carbonate, butylene carbonate, and γ-butyrolactone. Examples of the low-viscosity solvent include diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate.

Besides LiPF₆ used in the embodiment, examples of the electrolyte salt include LiN(C₂F₅SO₂)₂, LiN(CF₃SO₂)₂, LiClO₄ and LiBF₄ all of which can be used alone or in combination of two or more.

As described hereinbefore, the present invention provides a highly conductive sealing body with a safety valve, allowing a sealed cell including this sealing body to have a high current extraction efficiency, thereby providing high industrial applicability.

### REFERENCE MARKS IN THE DRAWINGS

1 terminal plate
2 insulating member
3 safety valve
5 terminal cap
7 welded part
8 electrode tab
9 melted-solidified region
10 sealing body
20 outer can
30 insulating gasket
40 electrode assembly
51 rivet fastener
61 press die
62 press die
71 press die
72 press die

What is claimed is:

1. A method for manufacturing a sealed cell sealed by caulking a sealing body around an opening of a bottomed cylindrical outer can, the method comprising the steps of:
producing a terminal cap made of an iron-based material, the terminal cap including an external terminal projecting toward an outside of the sealed cell, a flange in a periphery of the external terminal, and a hole in the flange, the hole having a diameter smaller on an inner side than on an outer side of the sealed cell;
producing a safety valve made of an aluminum-based material, the safety valve including a conductive contact portion projecting toward an inside of the sealed cell, a peripheral portion in a periphery of the conductive contact portion, and a pin-like projection in the peripheral portion;
riveting the pin-like projection of the safety valve and the hole of the terminal cap together by inserting the pin-like projection into the hole and crushing a tip of the pin-like projection; and
welding the terminal cap and the safety valve by applying high-energy radiation to a part of the terminal cap that is in a vicinity of a riveted part.

2. The method of claim 1, wherein
the hole of the terminal cap is a counterbored hole.

3. The method of claim 1, wherein
the high-energy radiation is a laser beam.

4. The method of claim 1, wherein
the high-energy radiation in the step of welding is applied to a wall surface of the hole of the terminal cap that is in the vicinity of the riveted part.

5. A sealed cell, comprising:
a bottomed cylindrical outer can; and
a sealing body caulked around an opening of the outer can, wherein
the sealing body includes:
a terminal cap made of an iron-based material, the terminal cap including an external terminal projecting toward an outside of the sealed cell; and a flange in a periphery of the external terminal; and
a safety valve made of an aluminum-based material and disposed on an inner side of the sealed cell than the terminal cap, the safety valve including a conductive contact portion projecting toward an inside of the sealed cell, and a peripheral portion in a periphery of the conductive contact portion, wherein
the flange of the terminal cap and the peripheral portion of the safety valve are welded together to form a welded part;
the welded part is positioned between inner and outer surfaces of the flange; and
the welded part is provided in a center thereof with a material of the safety valve, and in a periphery thereof with a melted-solidified region in which the material of the terminal cap and the material of the safety valve are blended together.
